(19) United States
(12) Patent Application Publication
(10) Pub. No.: US 2006/0030276 A1
(43) Pub. Date: Feb. 9, 2006

(54) Cellular mobile communication network operating method and system

(75) Inventors: Beatrix De Mathan, Paris (FR); Alain Brethereau, Viroflay (FR); Jean-Roch Houllier, Saint-Michel sur Orge (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/196,837

(22) Filed: Aug. 4, 2005

(30) Foreign Application Priority Data
Aug. 5, 2004 (FR) 04 08 656

(51) Int. Cl. H04B 1/40

(52) U.S. Cl. 455/77

(57) ABSTRACT

A cellular mobile communication network operating method comprises a step of calculating at least one adjustment frequency parameter representative of the adjustment frequency of at least one radio parameter associated with at least one network object and a step of using said at least one adjustment frequency parameter in at least one radio network optimization operation

### CROSS-REFERENCE TO RELATED APPLICATIONS

This application is based on French Patent Application No. 04 08 656 filed May 8, 2004, the disclosure of which is hereby incorporated by reference thereto in its entirety, and the priority of which is hereby claimed under 35 U.S.C. §119.

### BACKGROUND OF THE INVENTION

1. Field of the invention

The present invention relates generally to cellular mobile communication systems.

Cellular mobile communication systems are generally covered by standards and the corresponding standards published by the corresponding standardization organizations may be consulted for more information.

2. Description of the prior art

As shown in FIG. 1, a cellular mobile communication system may be divided into three subsystems:

a radio subsystem 1, also known as the “radio network”, essentially responsible for functions of transmission over the radio interface 2 and for managing radio resources, this radio subsystem also being known as the base station subsystem (BSS) in systems such as the Global System for Mobile communications (GSM) in particular, or the radio network subsystem (RNS) in systems such as Universal Mobile Telecommunication System (UMTS) in particular,

a routing subsystem 3 also known as the “fixed network” or the network subsystem (NSS), essentially responsible for functions of setting up calls and for managing mobility, this routing subsystem communicating with the radio subsystem and (as shown at 4) with external networks that are not specifically shown, and

an operation subsystem (OSS) 5 essentially enabling the operator to manage the network 6, consisting of the “radio network” 1 and the “fixed network” 3.

A system for operating a cellular mobile communication network can itself be divided into three subsystems, as shown in FIG. 2:

a subsystem 10 mainly responsible for processing operations corresponding to the execution of various operating tasks, this subsystem communicating with the operator via workstations 11,

a subsystem 12 mainly responsible for applying to the network 6 various commands issued by the subsystem 10 and receiving from the network 6 data needed for the processing carried out by the subsystem 10, and

a subsystem 13 providing the functions of communication between the subsystems 10 and 12.

Network operation encompasses various tasks, a particularly important one of which is optimization of the radio network. For the operator (also referred to hereinafter as the optimizer or user), this task of optimizing the radio network generally has the objective of achieving the required quality of service and using the available radio resources as efficiently as possible.

Radio network optimization in turn encompasses various functions, a particularly important one of which is a tuning (or radio configuration adjustment) function, enabling the operator, if necessary, to modify radio parameters, in particular logic parameters such as, for example, frequency allocation, power control, handover (intercellular transfer), etc. parameters.

The tuning function is executed in various steps. As a general rule, starting from an analysis of data such as configuration data and performance data in particular (such as quality of service indicators in particular), the optimizer can determine the best values of radio parameters to optimize the network, and the values determined in this way are then applied to the network.

Generally speaking, tools have been developed to assist the optimizer in this analysis, such as: quality of service monitoring, cartographic analysis, diagnostic tools, etc. Quality of service indicators have also been proposed, which may additionally be consolidated spatially and/or temporally, for example the call drop rate, which may be monitored on a day-by-day basis and on a cell-by-cell basis, for example.

This kind of analysis, and in particular the interpretation of the quality of service indicators, remains complex and difficult, however. Moreover, the increasing traffic to be managed and, in consequence of this, the ever increasing number of network elements installed, and thus of parameters to be processed, as well as the variety and complexity of the information to be analyzed (whether it comes from the network itself or from its geographical environment) make the task of the optimizer extremely complex.

As a general rule, there is therefore a requirement to facilitate the task of the optimizer so that the analysis tasks, and more generally the optimization tasks, can be effected more simply, more efficiently and more economically for the operator. The present invention in particular responds to this type of requirement.

### SUMMARY OF THE INVENTION

One aspect of the present invention is a cellular mobile communication network operating method comprising a step of calculating at least one adjustment frequency parameter representative of the adjustment frequency of at least one radio parameter associated with at least one network object and a step of using said at least one adjustment frequency parameter in at least one radio network optimization operation.

Another aspect of the present invention is a cellular mobile communication network operating system comprising:

means for calculating at least one adjustment frequency parameter representative of the adjustment frequency of at least one radio parameter associated with at least one network object, and

means for using said at least one adjustment frequency parameter in at least one radio network optimization operation.

Another aspect of the present invention is a cellular mobile communication network operating system workstation comprising means enabling the user to select at least one adjustment frequency parameter representative of the adjustment frequency of at least one radio parameter associated with at least one network object, for use in at least one radio network optimization operation.

Other aspects and features of the present invention will become apparent on reading the following description with reference to the appended drawings of embodiments of the invention.

### BRIEF DESCRIPTION OF THE DRAWINGS

FIG. 1 shows the general architecture of a cellular mobile communication system.

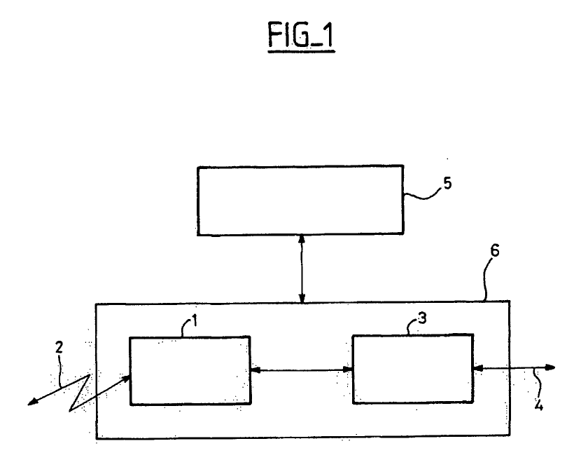

FIG. 2 shows the general architecture of a cellular mobile communication network operating system.

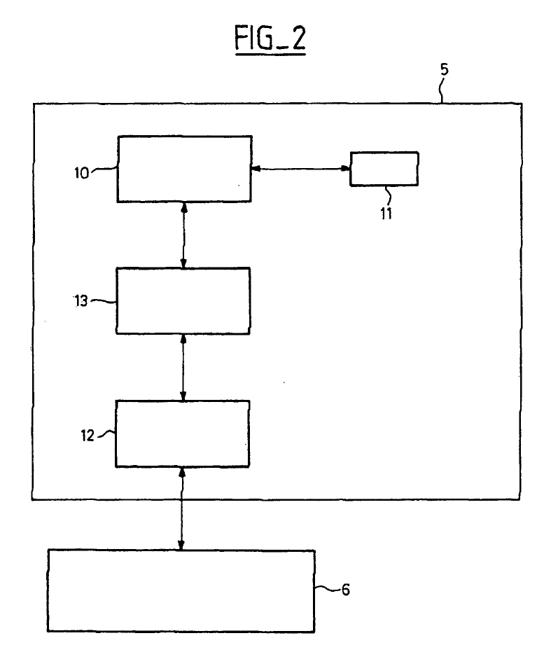

FIG. 3 is a diagram of one example of a method of the invention.

FIG. 4 is a diagram showing one example of the use of a reference cell (or more generally a reference object) for the tuning (radio configuration adjustment) function.

### DETAILED DESCRIPTION OF THE PREFERRED EMBODIMENT

One aspect of the present invention proposes a new type of indicator, referred to as the adjustment frequency indicator, that is different from existing indicators (such as the existing quality of service indicators referred to above) and indicates, for a given network object, the frequency of adjustment of at least one radio parameter associated with that network object.

The present invention is applicable to all types of network object that can be manipulated or managed in the context of radio network optimization operations.

For example, for the network object corresponding to a cell, an indicator of the above kind enables the optimizer to determine immediately for which cells the radio configuration is frequently adjusted, i.e. which cells are giving rise to radio configuration problems. Conversely, a cell for which the radio configuration is rarely adjusted is a cell giving rise to no radio configuration problems, and could therefore be selected as a reference cell whose radio configuration could be reproduced for other cells.

Examples of using reference cells (or more generally reference objects) for the tuning (radio configuration adjustment) function are described hereinafter.

Another aspect of the present invention proposes to define:

firstly, an indicator referred to as a “global indicator” that indicates, for the network object concerned, a “global” adjustment frequency, i.e. a frequency for the various types of adjustment operations and/or associated events, and

secondly, a family of indicators for indicating, for the network object concerned, the adjustment frequency according to the type of adjustment operation and/or associated event.

Another aspect of the present invention proposes to define:

a first indicator for indicating an adjustment operation counting result over a given counting period, and

a second indicator for indicating an adjustment frequency as such, or a counting result per unit counting time.

There are considered hereinafter, by way of example, firstly, the case of network objects corresponding to cells or to network elements of the base station controller type (base station controller (BSC) in a GSM type system, for example, or radio network controller (RNC) in a UMTS type system, for example); the network object corresponding to the network itself is then considered.

The radio parameters of a network can in particular be classified as: cell parameters (managed at cell level, their value can differ for each cell or for each group of cells), parameters measured at the BSC or RNC level, and network parameters (defined for the whole of the network).

Radio parameters managed at the level of a cell or a BSC/RNC are considered first.

One aspect of the present invention proposes to define, for each cell of the network, an indicator that gives the adjustment frequency of that cell.

Another aspect of the present invention proposes to define for each cell of the network:

a “global indicator” giving its “global” adjustment frequency, i.e. the adjustment frequency for the various types of adjustment operation and/or associated events, and

a family of indicators for refining the information supplied by the global indicator. The indicators of this family give the adjustment frequency of the cell according to the type of adjustment operation effected, linked to an event that can have an impact on the network.

For example, an indicator could give the adjustment frequencies of “adjacencies” (neighbor relationship between cells), another could give the adjustment frequency of the radio frequency for each cell, another could give the adjustment frequency of logic parameters of the cell, etc. Further examples of adjustment operations and/or associated events are given hereinafter.

As all the parameters managed at the cell level or at the BSC/RNC level are the same for all the cells of the network, thanks to these new indicators it is easy to compare the number of configuration changes effected for the various cells. These indicators are created when a cell is created (or at the time it is declared to be a new cell). They are initialized with a null value because, when the cell is created, no adjustment of the configuration of the cell has yet been effected.

Another aspect of the present invention proposes to define:

a first indicator (Ind1) that gives the number of times that a cell parameter has been adjusted for the cell concerned since it was created, and

a second indicator (Ind2) which gives the number of adjustments per unit counting time, i.e. the real adjustment frequency.

The indicator Ind1 is incremented for the cell each time that an adjustment operation is effected on one of the parameters defined for the cell. Note that this kind of incrementation is effected only if the adjustment operation has really been applied to the network, in order to avoid counting adjustment operations that are not in fact applied.

The indicator Ind2 is linked to the counting time period, in order to facilitate comparing the cells of the network. Not all the cells of the network are necessarily created at the same time. Their counting period may therefore be different, which could falsify the comparison.

With the above indicators defined for each cell of the network, the optimizer can tell immediately which cells are frequently adjusted and which are not. It can also consult a record (i.e. the evolution) of those indicators and establish a link with known events that might have an impact on the network (events specific to the network, such as a new frequency plan, for example, or events external to the network but that could have an impact on traffic, such as a major event in a given geographical area, for example).

This correlation with events is facilitated by the definition of a family of indicators for refining the information provided by a global indicator. In other words, a global indicator calculates a “global” adjustment frequency, i.e. a frequency for all types of adjustment operation and/or associated event, while the other indicators of the family give the adjustment frequency for each type of adjustment operation and/or associated event.

A non-exhaustive list of types of adjustment operation and/or event is given hereinafter:

Events Specific to the Network:

Adjacency adjustment operation: this operation consists in creating or eliminating neighbor relationships between cells in order to enable handover (intercellular transfer) between selected cells.

Adjacency parameter adjustment operations: this operation consists in adjusting one or more parameters associated with a neighbor relationship between two cells.

Change of cell capacity: this operation consists in increasing or decreasing the capacity of the cell to increase or decrease the traffic managed by the cell.

Change of cell type: this operation consists in modifying the coverage of the cell and/or the manner in which traffic is managed in the cell and in its neighbors.

Change of frequency: this operation consists in modifying the frequency of one or more cells.

Change of parameter: this operation consists in changing the value of one or more parameters having an impact on the algorithms used in the equipment.

Scheduled change of parameter: this operation consists in using scheduled new values for one or more parameters.

Change of standard version: this operation consists generally in adding new functions provided by a new version of the standard.

Change of topology: this operation concerns all changes made to the topology of the network, for example creating a new cell, eliminating a cell, transferring a cell from one BSC to another, etc.

Events External to the Network:

Day of departure on leave, etc.

Christmas, New Year, etc.

Event in an exhibition center, etc.

Etc.

Radio parameters managed at the level of the network itself (and not at the cell level) are considered next.

In the case of network parameters applied to the whole of the network, it is also beneficial to provide an adjustment frequency indicator, as it indicates if the adjustment of a network parameter is difficult (it is difficult if the parameter must be adjusted frequently).

Accordingly, one aspect of the present invention proposes to provide an indicator that gives the adjustment frequency for each network parameter. An indicator of this kind is used to determine which parameters are adjusted frequently and therefore more difficult to manage than others that are rarely adjusted. A network parameter that is rarely adjusted probably corresponds to a good reference value for the network, which it might be beneficial to propagate to other networks, for example.

Another aspect of the present invention, as for the indicators in respect of the cells, proposes to define a family of indicators for refining the information provided by a “global” indicator.

Another aspect of the present invention, and likewise as for the indicators in respect of cells, proposes also to define, for each network parameter:

a first indicator (Ind_a) that gives the number of times that a network parameter has been adjusted (i.e. modified) since the creation of the network, and

a second indicator (Ind_b) that gives the number of adjustments per unit counting time, i.e. the actual adjustment frequency.

As for the indicators in respect of cells, the optimizer can consult a record (i.e. the evolution) of these indicators and establish a link with known events that might have an impact on the network. This correlation with events is facilitated by the definition of a family of indicators for refining information supplied by a “global indicator”. In other words, a “global indicator” provides a “global” adjustment frequency, i.e. one for all types of adjustment operation and/or associated event, whereas the indicators of this family give the adjustment frequency per type of adjustment operation and/or associated event.

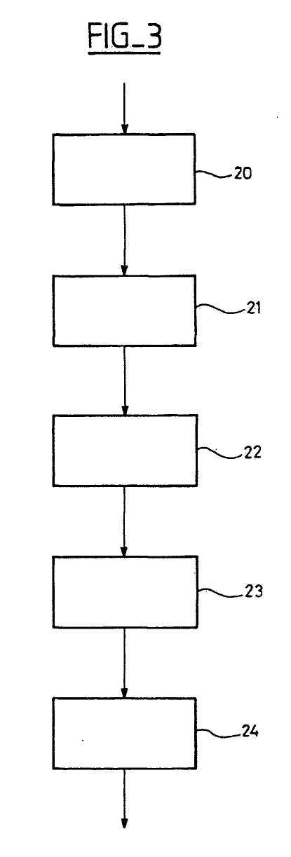

In other words, or more generally, a method of the invention for operating a cellular mobile communication network includes, as shown in the FIG. 3 example:

a step 23 of calculating at least one adjustment frequency parameter representative of the adjustment frequency of at least one radio parameter associated with at least one network object, and

a step 24 of using said at least one adjustment frequency parameter in at least one radio network optimization operation.

Furthermore, in the FIG. 3 example, the method includes a step 20 of selecting the network object and/or the associated radio parameter. In particular:

In one example, said network object corresponds to a cell or to a base station controller and said at least one associated radio parameter corresponds to at least one radio parameter managed at the cell level.

According to another example, said network object corresponds to the network itself, and said at lest one associated radio parameter corresponds to at least one radio parameter managed at the network level.

Furthermore, in the FIG. 3 example, the method includes a step 21 of indicator type selection, namely a “global” indicator or an indicator for each type of adjustment operation and/or associated event. In other words:

In one embodiment, said calculation step is effected for all types of adjustment operation and/or associated event.

In another embodiment, said calculation step is effected for each type of adjustment operation and/or associated event.

Furthermore, in the FIG. 3 example, the method includes a step 22 of adjustment frequency indicator calculation mode selection:

In a first calculation mode, said calculation step includes a count of adjustment operations over a given period.

In a second calculation mode, said calculation step includes a count of adjustment operations per unit counting time.

The present invention further provides a cellular mobile communication network operating system comprising means for calculating at least one adjustment frequency parameter representative of the adjustment frequency of at least one radio parameter associated with at least one network object and means for using said at least one adjustment frequency parameter in at least one radio network optimization operation.

The present invention further provides a cellular mobile communication network operating system workstation comprising means enabling the user to select at least one adjustment frequency parameter representative of the adjustment frequency of at least one radio parameter associated with at least one network object, for use in at least one radio network optimization operation.

The particular implementation of such means representing no particular difficulty for the person skilled in the art, such means do not need to be described here in more detail than by stating their function, as above.

All these new indicators may therefore be available for selection by the user, in any radio network optimization operation (like the existing quality of service indicators and the cell and network parameters). The optimizer can consult the value of these new indicators for each cell of the network, respectively for each parameter of the network. It can also define thresholds from which alarms are generated; for example, an alarm may be generated to alert the optimizer if the value of one of these new indicators is above a threshold defined in this way.

The present invention therefore enables the optimizer to see immediately which cells are giving rise to configuration problems and which cells whereof the radio configuration could be used as a reference (since the optimizer has not needed to adjust them often). For the network parameters, the present invention also enables the operator to see immediately which network parameters are difficult to adjust and which parameters may be defined as “good” values that it could be beneficial to apply to other networks. Furthermore, providing an entire family of indicators according to the type of adjustment operation/event facilitates an understanding of the network problems encountered because the operator will know immediately which types of adjustment have been needed often in cells that have given rise to quality of service problems. Thus the optimizer can tell better where to concentrate his efforts to improve the radio configuration.

Examples of using a reference cell (or more generally a reference object) for the tuning (radio configuration adjustment) function are described next.

Determining the best radio parameters for a cell is generally a difficult task that may necessitate many successive operations. Moreover, it is very often the case that the optimizer must carry out this task for the whole of an area of the network on which he is working. For example, the optimizer must define the best radio configuration to cover, with a good quality of service, an area in which an event takes place over a given period of time. The optimizer will generally attempt to adjust the radio configuration of a cell of that area to determine which radio parameter values are the best. As indicated above, that task may necessitate many successive adjustment operations.

Thereafter, when the optimizer has terminated the radio configuration adjustment operation for the cell initially selected, he has two options:

either to carry out the same radio configuration adjustment operation for all the other cells of the area concerned, in order to have the same radio parameter values for all the cells,

or, if the cells have been grouped beforehand into the same class of cells, he can apply the same radio parameters to all the cells of the class by means of a single adjustment operation.

The first solution has in particular the drawback of necessitating long and tiresome operations.

The second solution does not have those drawbacks, but presupposes that a class of cells has been defined beforehand, and therefore that criteria of belonging to that class have previously been defined, and that the cells satisfying those criteria have been selected beforehand to constitute a class of cells. In other words, this cell class concept leads to a solution that is relatively complex to implement.

Of the cell classes generally used, the following cell classes may be cited by way of example: Urban, Dense Urban, Rural, Suburban and Indoor. For all the cells belonging to the same class, the values of all the radio parameters are the same, and the user can modify the values of those parameters by means of a single tuning operation for all of the cells of the class. Note that this cell class concept includes a notion of duration: all the cells belonging to the same class are linked together in time. It is not possible to have a link of this kind for a defined period, for example a short period (such as the duration of a temporary event in particular). In other words, this cell class concept leads to a solution that lacks flexibility; in particular, this solution is not well suited to the situation of cell groups put together for the requirements of a temporary event.

To avoid some or all of the above drawbacks, or more generally to improve the optimization of mobile communication networks, a cellular mobile communication network operating method is proposed, said method including:

a step of selecting a reference object for a radio configuration adjustment operation carried out for a group of objects whereby all or part of the radio configuration of said reference object is reproduced on the objects of said group, and

a step of executing said radio configuration adjustment operation whereby all or part of the radio configuration of said selected reference object is reproduced on the objects of said group.

Similarly, a cellular mobile communication network operating system is proposed, said system comprising:

means for selecting a reference object for a radio configuration adjustment operation carried out for a group of objects whereby all or part of the configuration of said reference object is reproduced on the objects of said group, and

means for carrying out said radio configuration adjustment operation whereby all or part of the radio configuration of the selected reference object is reproduced on the objects of said group.

Similarly, a cellular mobile communication network operating workstation is proposed, said workstation including:

means enabling the user to select a reference object for a radio configuration adjustment operation carried out for a group of objects whereby all or part of the radio configuration of said reference object is reproduced on the objects of said group.

By way of example, the following description relates more particularly to objects corresponding to cells, but these principles are generally applicable to any type of object that can be manipulated or managed in the context of radio network optimization operations.

It is proposed to enable the optimizer to reproduce immediately, at the level of a group of cells that he has selected, the result of one or more tuning operations undertaken to define a best radio configuration for a selected cell (called the reference cell). The radio configuration of the reference cell is then copied/propagated to each cell of the group in a single operation.

Note that it is possible to reproduce either only the values of a subset of parameters defining the radio configuration or all of the parameters defining the radio configuration.

It is also proposed to define a new tuning (radio configuration adjustment) operation referred to as “radio configuration adjustment based on a reference cell”. This operation automatically reproduces the value of a set of selected parameters on all the cells of the selected group. This new operation may be defined by any type of system and/or any type of applicable standard, including the situation where more than one standard is applicable.

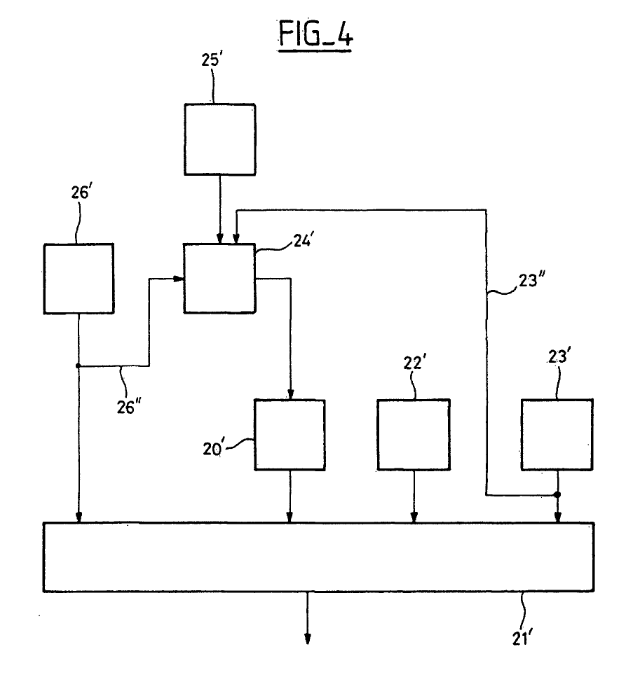

In other words, there is proposed a method that may comprise, as shown in FIG. 4:

a step 20′ of selecting a reference cell for a radio configuration adjustment operation carried out for a group of cells whereby some or all of the radio configuration of said reference cell is reproduced in the cells of said group, and

a step 21′ of executing said radio configuration adjustment operation whereby all or part of the radio configuration of the selected reference cell is reproduced in the cells of said group.

A method of the above kind may also comprise, as shown in FIG. 4:

a step 22′ of selecting at least one radio parameter representative of at least a portion of said radio configuration to be reproduced.

A method of the above kind may also comprise, as shown in FIG. 4:

a step 23′ of selecting cells forming said group.

A method of the above kind may also comprise, as shown in FIG. 4:

a step 24′ of establishing a list of reference cells from which said reference cell is selected in the step 20′.

Said list is advantageously established dynamically as a function of the group of cells concerned, as shown at 23′.

A method of the above kind may also comprise, as shown in FIG. 4:

a step 25′ of defining reference cells that may be included in said list of reference cells established in the step 24′.

A method of the above kind may also comprise, as shown in FIG. 4:

a step 26′ of selecting, from various types of radio configuration adjustment operation, a radio configuration adjustment operation type corresponding to said radio configuration adjustment operation carried out for a group of cells.

In particular, the step 24′ of establishing a list of reference cells may be commanded by the selection of a type of radio configuration adjustment operation corresponding to said radio configuration adjustment operation carried out for a group of cells, as shown at 26′.

Examples of using a method of the above kind are given hereinafter, these examples corresponding more particularly to the situation of a workstation using a graphical user interface (GUI) enabling the user to manipulate objects on a screen.

For example, it is possible to provide dialog means, for example a button, for selecting a “radio configuration adjustment based on a reference cell” type of radio configuration adjustment operation. For example, if the user clicks on this button, a list of reference cells is displayed in a new window. The user then selects in that window the reference cell that will be used in his radio configuration adjustment operation based on a reference cell. The parameter values selected of the reference cell selected will then be reproduced immediately in all of the cells of the group of cells that has been selected.

For example, the list of reference cells may be constructed using criteria to assist the user to select the best reference cell for the group of cells for which he wishes to carry out a tuning operation. By way of examples of such criteria there may be cited in particular the geographical proximity or cell characteristics such as the cell type (for example microcell, macrocell, etc.) or the cell class. In other words, the list of reference cells can be constructed dynamically for each group of cells for which the user wishes to carry out a tuning operation. For example, knowing, from the reference cells that are offered, which reference cell is the closest to that group of cells may be beneficial for the user (in particular in the case of particular events located in specific areas).

The cells in this list will have been defined beforehand as reference cells. For example, for this purpose, when the user clicks on the symbol selected to represent a cell on the screen, a contextual menu may be displayed which includes, among other operations on cells, defining the cell as a reference cell.

For example, it is also possible to add to the network objects corresponding to cells a new field indicating if the cell has been defined as a reference cell or not. For example, to enable reference cells to be distinguished immediately from other cells of the network it is possible to associate with this field means for indicating if a cell is a reference cell (for example by representing it in boldface characters, by means of a particular icon, etc.).

Similarly, there is proposed a cellular mobile communication network operating system that may therefore comprise:

means for selecting a reference object for a radio configuration adjustment operation carried out for a group of objects whereby all or part of the radio configuration of said reference object is reproduced in the objects of said group, and

means for carrying out said radio configuration adjustment operation whereby all or part of the radio configuration of said selected reference object is reproduced in the objects of said group.

Similarly, a workstation is proposed for the above type of cellular mobile communication network operating system, thus able to comprise, separately or in combination:

means enabling the user to select a reference object for a radio configuration adjustment operation carried out for a group of objects whereby all or part of the radio configuration of said reference object is reproduced on the objects of said group,

means enabling the user to select at least one radio parameter representative of at least one portion of said radio configuration to be reproduced,

means enabling the user to select the objects forming said group,

means enabling the user to select, from various types of radio configuration adjustment operation, a type of radio configuration adjustment operation corresponding to said radio configuration adjustment operation carried out for a group of objects,

means for proposing to the user a list of reference objects from which said reference object is selected (said list being advantageously established dynamically as a function of the group of objects concerned),

means enabling the user to define reference objects that may be included in said list of reference objects, and

means enabling the user to distinguish immediately reference objects from other objects of the network.

The particular implementation of such means representing no particular problem for the person skilled in the art, such means do not need to be described here in more detail than by stating their function, as above.

There is claimed:

1. A cellular mobile communication network operating method comprising:
a step of calculating at least one adjustment frequency parameter representative of the adjustment frequency of at least one radio parameter associated with at least one network object, and
a step of using said at least one adjustment frequency parameter in at least one radio network optimization operation.

2. The method claimed in claim 1, wherein said calculation step includes counting adjustment operations over a given period.

3. The method claimed in claim 1, wherein said calculation step includes counting adjustment operations per unit counting time.

4. The method claimed in claim 1, wherein said calculation step is effected for all types of adjustment operation and/or associated event.

5. The method claimed in claim 1, wherein said calculation step is effected for each type of adjustment operation and/or associated event.

6. The method claimed in claim 1, wherein said network object corresponds to a cell or to a base station controller and said at least one associated radio parameter corresponds to at least one radio parameter managed at the level of the cell.

7. The method claimed in claim 1, wherein said network object corresponds to the network itself and said at least one associated radio parameter corresponds to at least one radio parameter managed at the level of the network.

8. A cellular mobile communication network operating system comprising:
means for calculating at least one adjustment frequency parameter representative of the adjustment frequency of at least one radio parameter associated with at least one network object, and
means for using said at least one adjustment frequency parameter in at least one radio network optimization operation.

9. A cellular mobile communication network operating system workstation comprising:
means enabling the user to select at least one adjustment frequency parameter representative of the adjustment frequency of at least one radio parameter associated with at least one network object, for use in at least one radio network optimization operation.
